(19) United States
(12) Patent Application Publication
(10) Pub. No.: US 2026/0180117 A1
(43) Pub. Date: Jun. 25, 2026

(54) ENERGY STORAGE DEVICE

(71) Applicant: Prime Planet Energy & Solutions, Inc., Tokyo (JP)

(72) Inventor: Yozo UCHIDA, Toyota-shi (JP)

(21) Appl. No.: 19/426,062

(22) Filed: Dec. 19, 2025

(30) Foreign Application Priority Data
Dec. 24, 2024 (JP) 2024-226843

(51) Int. Cl. H01M 50/342; H01M 50/119

(52) U.S. Cl. CPC H01M 50/3425; H01M 50/119

(57) ABSTRACT

Provided is a technique to break a case properly when an internal pressure of the case reaches a predetermined pressure. A herein disclosed energy storage device includes a case that is made of a first metal, includes a metallic piece that is welded to the case and that is made of a second metal being different from the first metal, and includes an intermetallic compound of the first metal and the second metal, the intermetallic compound being provided on a welded part of the case and the metallic piece.

### CROSS REFERENCE TO RELATED APPLICATIONS

The present application claims the priority based on Japanese Patent Application No. 2024-226843 filed on Dec. 24, 2024, the entire contents of which are incorporated in the present description by reference.

### BACKGROUND OF THE DISCLOSURE

### 1. Technical Field

A present disclosure relates to an energy storage device.

### 2. Background

As an example of an energy storage device, it is possible to use a secondary battery, such as lithium ion secondary battery. Recently, this type of energy storage device is, for example, suitably used in a power supply for driving automobiles, such as battery electric vehicle (BEV), hybrid electric vehicle (HEV), and plug-in hybrid electric vehicle (PHEV), or the like.

A lithium ion secondary battery disclosed in Japanese Patent Application Publication No. 2012-9317 includes a wound electrode group, which is configured to have a cross section formed in an oval shape and in which a positive electrode plate including a non-coated part of an active material mix agent at one side along a longitudinal direction and a negative electrode plate including a non-coated part of an active material mix agent at one side along the longitudinal direction are wound therein via a separator so as to make the non-coated parts of the positive and negative electrode plates be arranged respectively at opposite sides, includes a square shape battery container, which is configured to accommodate the wound electrode group so as to make a winding axis of the wound electrode group be parallel to a longitudinal direction of a bottom surface, and includes a gas release valve which is provided at a side surface of the battery container. Regarding the wound electrode group, the non-coated parts of the positive and negative electrode plates are joined at a portion between bent parts at which the positive and negative electrode plates are bent over, and further the bent part includes openings at wound both end surfaces. At least one gas release valve is arranged on an area where an opening of the bent part is projected to a side surface of a battery container.

This patent document describes that, by the configuration described above, an exhaust pathway of a gas generated from the wound electrode group and a gas release valve are arranged in a linear manner so as to make a distance between the gas exhaust pathway and the gas release valve become shorter, thus a gas release can be performed smoothly at a gas release valve operating time, and therefore it is possible to implement a lithium ion secondary battery in which both of a safety property and a reliability are satisfied.

### SUMMARY

The present inventor has thought to properly break a case when an internal pressure of the case reaches a predetermined pressure.

The herein disclosed energy storage device includes a case that is made of a first metal, includes a metallic piece that is welded to the case and that is made of a second metal being different from the first metal, and includes an intermetallic compound of the first metal and the second metal, the intermetallic compound being provided on a welded part of the case and the metallic piece. In accordance with such a configuration, it is possible to properly break the case when the internal pressure of the case reaches the predetermined pressure.

### BRIEF DESCRIPTION OF THE DRAWINGS

FIG. 1 is a perspective view of an energy storage device 1.

FIG. 2 is a perspective view of the energy storage device 1.

FIG. 3 is an III-III cross section view of FIG. 1.

FIG. 4 is a plane view of a bottom surface 11 and a metallic piece 60.

FIG. 5 is a schematic view of an electrode assembly 30.

FIG. 6 is a plane view of a welded part 265.

### DESCRIPTION OF THE EMBODIMENTS

Below, one embodiment of a herein disclosed energy storage device will be explained. The embodiment explained herein is not to particularly restrict the herein disclosed technique. The herein disclosed technique is not restricted to the embodiment explained herein, unless specifically mentioned. Drawings are schematically illustrated, and thus are not to always reflect actual things. The members/parts providing the same effect are suitably provided with the same numerals and signs, and overlapping explanations might be omitted. In drawings, reference signs “X”, “Y”, and “Z” respectively represent “first direction”, “second direction”, and “third direction” of the present description. In drawings, reference signs “X1”, “X2”, “Y1”, “Y2”, “Z1”, and “Z2” represent directions of the drawings. However, these directions are defined for convenience sake of explanation, and are not intended to restrict a disposed aspect of the energy storage device at all. A wording “A to B” representing a numerical range not only means “equal to or more than A and not more than B” unless specifically mentioned, but also semantically covers a meaning of “more than A and less than B”.

In the present description, a term “energy storage device” represents a device in which an electrical charge and an electrical discharge are generated in response to movement of an electrical charge carrier between a pair of electrodes (a positive electrode and a negative electrode) through an electrolyte. The energy storage device semantically covers a secondary battery, such as lithium ion secondary battery, nickel hydrogen battery, and nickel cadmium battery; and a capacitor, such as lithium ion capacitor and electric double layer capacitor. The energy storage device might be, for example, a lithium ion secondary battery.

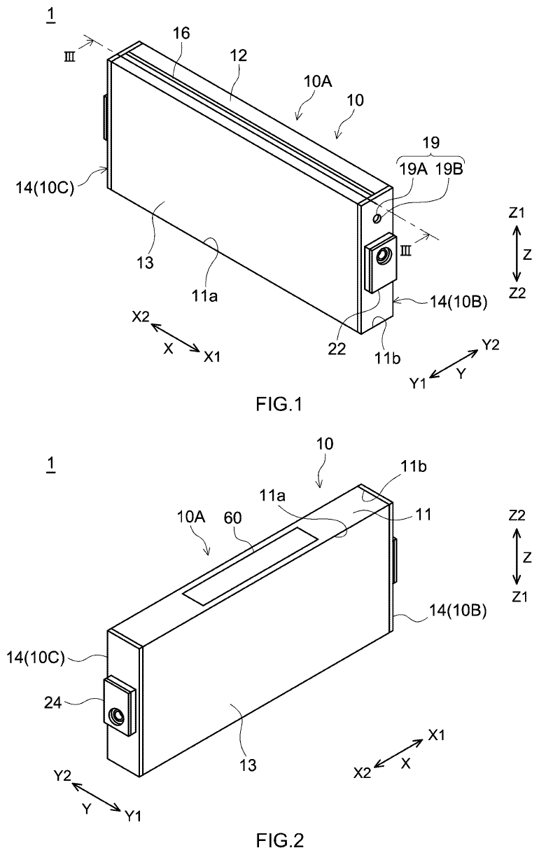

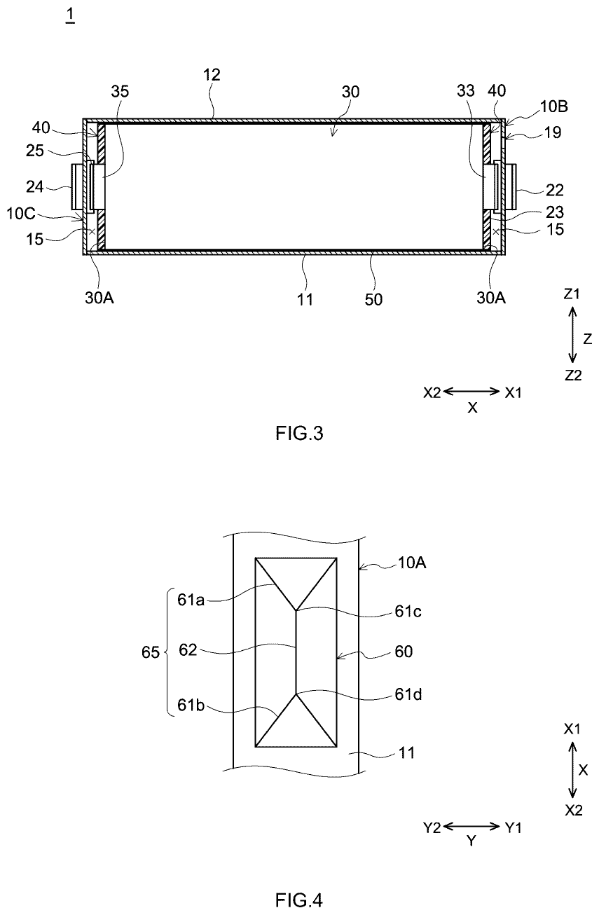

FIG. 1 and FIG. 2 are perspective views of an energy storage device 1. FIG. 1 shows the energy storage device 1 in a situation where a Z1 side is defined as an upper side in drawings. In FIG. 1, an upper surface 12 of the energy storage device 1 is arranged at the upper side in the drawing. FIG. 2 shows the energy storage device 1 in a situation where a Z2 side is defined as an upper side in the drawing. In FIG. 2, a bottom surface 11 of the energy storage device 1 is arranged at the upper side in the drawing. FIG. 3 is an III-III cross section view of FIG. 1. FIG. 3 shows a cross section structure of the energy storage device 1 in a situation where one of first side surfaces 13 (here, the first side surface 13 at an Y1 side) is arranged on a front.

As shown in FIG. 1 to FIG. 3, the energy storage device 1 includes a case 10, a positive electrode terminal 22, a negative electrode terminal 24, an electrode assembly 30, a spacer 40, a resin film 50, and an electrolytic solution (not shown in drawings). The energy storage device 1 herein is a lithium ion secondary battery.

As shown in FIG. 1 to FIG. 3, the case 10 includes a bottom surface 11, an upper surface 12, a pair of first side surfaces 13 opposed to each other, and a pair of second side surfaces 14 opposed to each other. The case 10 herein is formed in a hexahedronal shape. In this embodiment, the bottom surface 11 and the upper surface 12 are formed to be rectangular and are opposed to each other. In embodiments shown in FIG. 1 and FIG. 2, the pair of opposed first side surfaces 13 are configured to extend from a pair of opposed long sides 11a of the bottom surface 11, and to have relatively larger area sizes. The pair of opposed second side surfaces 14 are configured to extend from a pair of opposed short sides 11b of the bottom surface 11 and to have relatively smaller area sizes.

As shown in FIG. 1 to FIG. 3, the case 10 includes a body 10A, a first sealing plate 10B, and a second sealing plate 10C. The body 10A is, for example, formed in a square tube shape, and includes the bottom surface 11, the upper surface 12, and the pair of opposed first side surfaces 13. In this embodiment, regarding body 10A, a portion surrounded by the bottom surface 11, the upper surface 12, and the pair of opposed first side surfaces 13 is configured to be an opening. As shown in FIG. 3, the energy storage device 1 includes two openings 15.

The body 10A can be manufactured, for example, by folding and bending one metal plate so as to mold it in a cylindrical shape, and then by joining (for example, welding and joining) a seam. Thus, as shown in FIG. 1, the body 10A includes a joint part 16 that is configured to extend along the first direction X on the upper surface 12.

The body 10A is made of a first metal. The first metal might be, for example, aluminum, aluminum alloy, iron, iron alloy (for example, stainless steel), or the like, or might be an H steel in which the aluminum, the aluminum alloy, the iron, the iron alloy, or the like are work-hardened. Incidentally, in the present description, a wording “alloy” means a metal material that contains a metal A, another metal B being different from the metal A, and/or a non-metal, and that does not contain an intermetallic compound described later. The aluminum alloy herein is an alloy containing the aluminum being equal to or more than 50 mass % with respect to the whole and being not more than 95%. The iron alloy herein is an alloy containing the iron being equal to or more than 50 mass % with respect to the whole and being not more than 95%. A later described copper alloy herein is an alloy containing copper being equal to or more than 50 mass % with respect to the whole and being not more than 95%.

As shown in FIG. 2, the body 10A includes a metallic piece 60. The body 10A includes the metallic piece 60 at an outer side of the case 10. In this embodiment, the body 10A includes the metallic piece 60 on the bottom surface 11. The metallic piece 60 is formed in a plate shape. The metallic piece 60 herein is made of a second metal. The second metal is a metal being different from the first metal. It is good that the second metal is, for example, the copper, the copper alloy, the iron, the iron alloy, the aluminum, the aluminum alloy, or the like.

In this embodiment, the metallic piece 60 is welded to the body 10A on the bottom surface 11. As a welding means for the metallic piece 60 and the body 10A, for example, from a perspective of appropriately forming the intermetallic compound on the welded parts of them, it is possible to preferably use a laser welding or a resistance welding.

FIG. 4 is a plane view of the bottom surface 11 and the metallic piece 60. As shown in FIG. 4, the welded part 65 of the body 10A and the metallic piece 60 includes two first weld lines 61a, 61b and a second weld line 62. The first weld lines 61a, 61b herein are formed in V shapes. Thus, the first weld lines 61a, 61b and the second weld line 62 are respectively configured to extend in directions different from each other and to cross at apexes 61c, 61d. On the metallic piece 60, one first weld line 61a is arranged at a X1 side in a first direction X so as to make the apex 61c be positioned at an inner side of the metallic piece 60. On the metallic piece 60, another first weld line 61b is arranged at a X2 side in the first direction X so as to make the apex 61d be positioned at the inner side of the metallic piece 60. The second weld line 62 is formed in a linear manner, is configured to cross one first weld line 61a at the apex 61c and cross another first weld line 61b at the apex 61d.

In this embodiment, at the welded part 65 of the case 10 (here, the body 10A) and the metallic piece 60, an intermetallic compound of the first metal and the second metal is formed. A kind of the intermetallic compound depends on a kind of the first metal and a kind of the second metal. In the present description, the wording “intermetallic compound” represents a solid substance configured with at least 2 or more metal elements, represents a chemical compound having a structure and a property which are clearly different from a constituent metal, and does not contain the above described alloy. For example, when the first metal is the aluminum or the aluminum alloy and the second metal is the copper or the copper alloy, it is possible as the intermetallic compound to generate the intermetallic compound of the aluminum and the copper (for example, Al₄Cu₉, Al₂Cu, or the like). When the first metal is the aluminum or the aluminum alloy and the second metal is the iron or the iron alloy, it is possible as the intermetallic compound to generate the intermetallic compound of the aluminum and the iron (for example, Fe₃Al, FeAl, FeAl₂, Fe₂Al₅, FeAl₃, or the like). When the first metal is the iron or the iron alloy and the second metal is the aluminum or the aluminum alloy, it is possible as the intermetallic compound to generate the above described intermetallic compound of the aluminum and the iron. When the first metal is the iron or the iron alloy and the second metal is the copper or the copper alloy, it is possible as the intermetallic compound to generate the intermetallic compound of the iron and the copper.

A timing for providing the welded part 65 is not particularly restricted. For example, before a metal plate configuring the body 10A is folded and bent, the metallic piece 60 might be mounted on the metal plate so as to provide the welded part 65. In this situation, it is good that the metal plate, on which the welded part 65 is provided, is folded and bent, so as to obtain the body 10A formed in a cylindrical shape. Alternatively, it is also good that, after the cylindrical body 10A is obtained by folding and bending the metal plate, the metallic piece 60 is mounted on the body 10A so as to provide the welded part 65.

In this embodiment, the welded part 65 functions as a gas exhaust part of the case 10. The gas exhaust part is a portion designed, for example, to be broken so as to release an internal pressure of the case 10 when the internal pressure reaches a predetermined value. Thus, the welded part 65 is broken when the internal pressure of the case 10 reaches the predetermined value. Regarding the internal pressure of the case 10 when the welded part 65 is broken, for example, it is good to be 1.0 MPa, but it might be lower or higher than this value as needed. Although not particularly restricting, for example, by suitably adjusting a welding depth at the welded part 65, it is possible to set the internal pressure of the case 10 at which the welded part 65 can be broken. Incidentally, the gas exhaust part might not be always provided on the bottom surface 11. In another embodiment, the gas exhaust part might be provided on the upper surface 12 or the first side surface 13.

The first sealing plate 10B is, for example, a member configured to seal one of openings 15. The first sealing plate 10B is, for example, a plate-shaped member that is formed in an approximately rectangular shape. In this embodiment, the first sealing plate 10B is fit into one of the openings 15 and then joined by welding (for example, laser welding). As shown in FIG. 1 and FIG. 3, the positive electrode terminal 22 is attached to the first sealing plate 10B.

In this embodiment, the first sealing plate 10B includes a liquid injection part 19. The liquid injection part 19 includes a liquid injection hole 19A and a sealing plug 19B. The liquid injection hole 19A herein is a portion through which an electrolytic solution is injected into the case 10 at a manufacture process of the energy storage device 1. In this embodiment, the liquid injection hole 19A is provided closer to the upper surface 12 on the first sealing plate 10B. The sealing plug 19B herein is a member for covering the liquid injection hole 19A.

The second sealing plate 10C is, for example, a member for sealing the other one of openings 15. The second sealing plate 10C is, for example, a plate-shaped member that is formed in an approximately rectangular shape. In this embodiment, the second sealing plate 10C is fit into the other one of openings 15 and then joined by welding (for example, laser welding). As shown in FIG. 2 and FIG. 3, the negative electrode terminal 24 is attached to the second sealing plate 10C.

In forms shown by FIG. 1 to FIG. 3, the first sealing plate 10B and the second sealing plate 10C configure a pair of opposed second side surfaces 14. The first sealing plate 10B and the second sealing plate 10C are, for example, preferably configured with a metal material (here, the first metal) that is the same as the metal material configuring the body 10A.

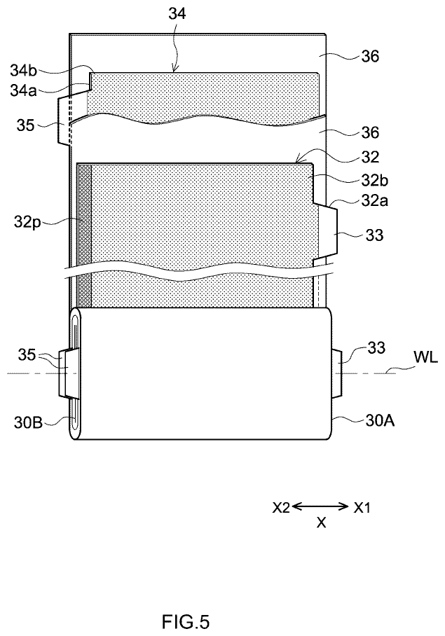

The positive electrode terminal 22 is, for example, electrically connected to a positive electrode 32 of the electrode assembly 30 (see FIG. 5). As shown in FIG. 1 and FIG. 3, the positive electrode terminal 22 is attached to the first sealing plate 10B. As shown in FIG. 3, the positive electrode terminal 22 is electrically connected to a positive electrode tab 33 of the electrode assembly 30 via a positive electrode current collector part 23. The positive electrode terminal 22 is, for example, made of metal, and is preferably mad of aluminum or aluminum alloy. Incidentally, the positive electrode terminal 22 might configure the positive electrode current collector part 23.

The negative electrode terminal 24 is, for example, electrically connected to a negative electrode 34 of the electrode assembly 30 (see FIG. 5). As shown in FIG. 2 and FIG. 3, the negative electrode terminal 24 is attached to the second sealing plate 10C. As shown in FIG. 3, the negative electrode terminal 24 is electrically connected to a negative electrode tab 35 of the electrode assembly 30 via a negative electrode current collector part 25. The negative electrode terminal 24 is, for example, made of metal, and is preferably made of copper or copper alloy. Incidentally, the negative electrode terminal 24 might configure the negative electrode current collector part 25.

The electrode assembly 30 is, for example, a power generating element of the energy storage device 1. As shown in FIG. 3, the electrode assembly 30 is accommodated in the case 10. FIG. 5 is a schematic view of the electrode assembly 30. As shown in FIG. 5, the electrode assembly 30 includes the positive electrode 32, the negative electrode 34, and the separator 36 disposed between the positive electrode 32 and the negative electrode 34. In this embodiment, the electrode assembly 30 is a flat-shaped wound electrode assembly in which the long sheet-shaped positive electrode 32 and the long sheet-shaped negative electrode 34 are laminated with the long sheet-shaped separator 36 disposed between them and then are wound in a sheet longitudinal direction. A reference sign “WL” in FIG. 5 represents a winding axis of the electrode assembly 30.

As shown in FIG. 3 and FIG. 5, the electrode assembly 30 includes a first end surface 30A that is positioned at one of end parts in a direction along the winding axis WL (the first direction X of FIG. 3 and FIG. 5) and includes a second end surface 30B that is positioned at the other one of end parts in the same direction. In this embodiment, the first end surface 30A and the second end surface 30B are laminate surfaces of the electrode and the separator 36, and are open surfaces configured to be open toward an outer side of the electrode assembly 30. As shown in FIG. 3, the first end surface 30A is opposed to the first sealing plate 10B. The second end surface 30B is opposed to the second sealing plate 10C.

In forms shown by FIG. 3 and FIG. 5, the electrode assembly 30 includes the positive electrode tab 33 on the first end surface 30A, while the positive electrode tab is connected to the positive electrode 32. The electrode assembly 30 includes the negative electrode tab 35 on the second end surface 30B, while the negative electrode tab is connected to the negative electrode 34. The positive electrode tab 33 herein is provided on each positive electrode 32 contained in the electrode assembly 30. The positive electrode tabs 33 provided on respective positive electrodes 32 (plural positive electrode tabs 33) are, for example, superimposed so as to configure a positive electrode tab group. The negative electrode tab 35 herein is provided on each negative electrode 34 contained in the electrode assembly 30. The negative electrode tabs 35 provided on respective negative electrodes 34 (plural negative electrode tabs 35) are, for example, superimposed so as to configure a negative electrode tab group.

As shown in FIG. 5, the positive electrode 32 includes a long strip-shaped positive electrode current collector foil 32a and a positive electrode active material layer 32b that is provided on a surface of the positive electrode current collector foil 32a. The positive electrode current collector foil 32a includes plural positive electrode tabs 33 at one of end parts in a shorter direction, while the plural positive electrode tabs are arranged intermittently along a longitudinal direction. The positive electrode tab 33 herein is an exposed part of the positive electrode current collector foil 32a. It is good that the positive electrode current collector foil 32a is, for example, made of aluminum or aluminum alloy. The positive electrode active material layer 32b is a layer that contains a positive electrode active material and the other arbitrary component (for example, a binder, an electrically conducting material, or the like). In this embodiment, the positive electrode current collector foil 32a includes a protection layer 32p at the other one of end parts in the shorter direction, while the protection layer is configured to extend along the longitudinal direction. It is good that the protection layer 32p is, for example, a layer that contains an inorganic filler and a resin binder. Incidentally, as a configuration material of the positive electrode 32, it is possible without particular restriction to use, for example, a material being used for the positive electrode of this kind of energy storage device.

As shown in FIG. 5, the negative electrode 34 includes a long strip-shaped negative electrode current collector foil 34a and a negative electrode active material layer 34b that is provided on a surface of the negative electrode current collector foil 34a. The negative electrode current collector foil 34a includes plural negative electrode tabs 35 at one of end parts in the shorter direction, while the plural negative electrode tabs are arranged intermittently along the longitudinal direction. The negative electrode tab 35 herein is an exposed part of the negative electrode current collector foil 34a. It is good that the negative electrode current collector foil 34a is, for example, made of copper or copper alloy. The negative electrode active material layer 34b is a layer that contains a negative electrode active material and the other arbitrary component (for example, the binder, a conductive assistant agent, a thickening agent, or the like). Incidentally, as a configuration material of the negative electrode 34, it is possible without particular restriction to use, for example, a material being used for the negative electrode of this kind of energy storage device.

As the separator 36, for example, it is possible without particular restriction to use the separator used for this kind of energy storage device. The separator 36 might have a single layer structure, or have a two or more layers structure, for example, three layers structure, while the layers respectively have different properties and characteristics (thicknesses, porosities, or the like). The separator 36 is, for example, made of resin, or is preferably made of polyolefin resin. It is good that the polyolefin resin is polyethylene, polypropylene, or mixture of them.

As the electrolytic solution, for example, it is possible without particular restriction to use an electrolytic solution used for this kind of energy storage device. The electrolytic solution is, for example, a nonaqueous electrolytic solution that contains a nonaqueous solvent (an organic solvent) and a supporting salt. As the nonaqueous solvent, for example, it is possible to use carbonates, such as ethylene carbonate, dimethyl carbonate, and ethyl methyl carbonate. As the supporting salt, for example, it is possible to use a fluorine-containing lithium salt, such as lithium hexafluorophosphate (LiPF₆).

The spacer 40 is, for example, a member arranged between the case 10 and the electrode assembly 30. In the embodiment shown by FIG. 3, the spacer 40 is arranged between the case 10 and the first end surface 30A of the electrode assembly 30. As shown in FIG. 3, the spacer 40 is arranged between the first sealing plate 10B and the electrode assembly 30 (the first end surface 30A at the X1 side) and further arranged between the second sealing plate 10C and the electrode assembly 30 (the first end surface 30A at the X2 side). Incidentally, it is good that the spacer 40 is, for example, configured with an insulating property resin (for example, a polyamide resin, or the like) that is conventionally used for this kind of energy storage device.

The resin film 50 is, for example, a member that is configured to establish an insulation between the case 10 and the electrode assembly 30. As shown in FIG. 3, the resin film 50 is arranged to surround an outer periphery of the electrode assembly 30. In this embodiment, the resin film 50 is formed in a cylindrical shape, and is configured to accommodate the electrode assembly 30 at the inside. As a resin material configuring the resin film 50, for example, it is good to use a resin material configuring the resin film contained in this kind of energy storage device. As the resin material described above, for example, it is good to use a polyamide resin, a polyolefin resin (polyethylene, polypropylene, or the like), or the like.

The energy storage device 1 can be used for various purposes, but among them, it is preferably used as a power source for a motor (a driving power supply) mounted on a vehicle, such as passenger car and truck. Although the type of the vehicle is not particularly restricted, it is possible as a suitable example to be a plug-in hybrid electric vehicle (PHEV), a hybrid electric vehicle (HEV), a battery electric vehicle (BEV), or the like.

As described above, the energy storage device 1 includes the case 10 and the metallic piece 60. The case 10 is made of the first metal. The metallic piece 60 is welded to the case 10 and is made of the second metal being different from the first metal. The energy storage device 1 includes the intermetallic compound of the first metal and the second metal at the welded part 65 of the case 10 and the metallic piece 60.

In other words, regarding the energy storage device 1, the case 10 includes the welded part 65 configured with the metallic piece 60 and includes the intermetallic compound at the welded part, as the intermetallic compound is generated by welding the first metal and the second metal which are different from each other. The portion at which the intermetallic compound exists is a weak portion of the case 10. Thus, when the internal pressure of the case 10 is increased and reaches the predetermined value, the weak portion (in other words, the portion at which the intermetallic compound exists) is broken. By this, it is possible to release the internal pressure of the case 10, and thus it is possible to further safely use the energy storage device 1.

The case 10 might include the welded part 65 as the gas exhaust part. By this, for example, it is possible to omit forming the gas exhaust part with a pressing process, or the like. Thus, it is possible to provide the gas exhaust part on the case 10, more easily. The effect induced by the above described configuration can be further preferably implemented, for example, in a situation where the gas exhaust part is formed on the case 10 whose material, shape, or configuration makes conducting the pressing process be difficult.

The welded part 65 might be configured to be broken when the internal pressure of the case 10 reaches 1.0 MPa. By this, it is possible to further properly enhance the safety property when the energy storage device 1 is used.

In a plane view, the welded part 65 might contain a linear portion (here, the first weld lines 61a, 61b and the second weld line 62). By this, the intermetallic compound is provided in a linear manner on the case 10 and thus the weak portion is provided in a linear manner. When the internal pressure of the case 10 is increased to expand the case 10 and additionally the internal pressure reaches the predetermined value, the weak portion is broken by the stress due to the expansion applied onto the case 10. Here, when the weak portion is formed in the linear manner, it is broken further easily and thus a portion being broken tends to easily spread. Therefore, the effect of the herein disclosed technique can be further easily implemented, and additionally it is possible to further enhance the safety property for using the energy storage device 1.

In a plane view, the welded part 65 might contain the first weld lines 61a, 61b and the second weld line 62. The first weld lines 61a, 61b and the second weld line 62 might be configured to respectively extend in directions different from each other, and might cross each other on at least one point (here, the apex 61c and the apex 61d). In this situation, the welded part 65 includes the intermetallic compound disposed along the first weld lines 61a, 61b and the second weld line 62. In other words, on the case 10, the weak portion is provided along the first weld lines 61a, 61b and the second weld line 62. A shape of the above described welded part 65 is a shape that is set to make the case 10 be easily broken when the stress due to the expansion is applied. Thus, the effect of the herein disclosed technique can be further easily implemented, and additionally it is possible to further enhance the safety property for using the energy storage device 1.

The energy storage device 1 might include the metallic piece 60 at the outer side of the case 10. By this, it is possible to further easily provide the welded part 65. Although not particularly restricting, in that situation, it is preferable that the metallic piece 60 is, for example, formed in a plate shape. By this, it is possible to implement space saving, and therefore, it is preferable, for example, when an energy storage module is constructed or the like.

The case 10 might include the cylindrical body 10A that has openings 15 at both ends, and include a pair of sealing plates (here, the first sealing plate 10B and the second sealing plate 10C) that are configured to seal the openings 15. The welded part 65 might be provided on the body 10A. It is difficult to provide the gas exhaust part on the cylindrical body 10A by the pressing process, or the like. However, the welded part 65 is provided, for example, by laminating the metallic piece 60 on the body 10A and then by welding both, and thus it is possible to further easily provide the gas exhaust part on the cylindrical body 10A.

The first metal might be aluminum or aluminum alloy. The second metal might be copper or copper alloy. By welding the aluminum and the copper, it tends to easily generate the weak intermetallic compound. Thus, in the combination of the first metal and the second metal described above, it is possible to further properly implement the effect of the herein disclosed technique.

The first metal might be an H steel of the aluminum or the aluminum alloy. For example, the H steel has a high hardness, and it is difficult to perform the pressing process on the H steel. Therefore, regarding the case 10 that is made of the first metal and that is the H steel of the aluminum or the aluminum alloy, it is possible to further properly implement the effect of the herein disclosed technique.

Above, although the embodiments of the herein disclosed technique have been explained, the embodiments are merely illustrative, and are not construed as limiting the scope of the appended claims. The technique recited in patent claims contains matters, for example, in which the above described embodiment is variously deformed or changed.

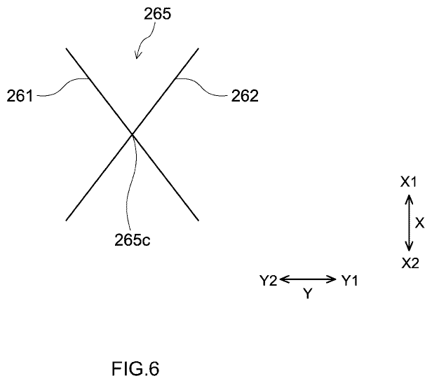

For example, in the above described embodiment, the welded part 65 includes a shape shown by FIG. 4. However, the shape of the welded part with the case 10 and the metallic piece 60 is not restricted to the above described shape. A shape illustrated below as the shape of the welded part and the other shape are preferable for implementing the effect of the herein disclosed technique. FIG. 6 is a plane view of the welded part 265. As shown in FIG. 6, the welded part 265 includes a first weld line 261 and a second weld line 262. The first weld line 261 and the second weld line 262 are configured to respectively extend in different directions and to cross each other at the intersection point 265c. In the form shown by FIG. 6, an angle formed by the first weld line 261 and the second weld line 262 is an obtuse angle or an acute angle. The first weld line 261 and the second weld line 262 configure a X shape. The wording “X shape” contains a cross shape formed by 2 weld lines orthogonal to each other.

The herein disclosed technique could contain techniques recited in below-described

### ITEMS

### Item 1:

An energy storage device, comprising:
a case that is made of a first metal;
a metallic piece that is welded to the case and that is made of a second metal being different from the first metal; and
an intermetallic compound of the first metal and the second metal, the intermetallic compound being provided on a welded part of the case and the metallic piece.

### Item 2:

The energy storage device recited in Item 1, wherein
the case comprises the welded part as a gas exhaust part.

Item 3: The energy storage device recited in Item 1 or 2, wherein
the welded part is configured to be broken when an internal pressure of the case reaches 1.0 MPa.

### Item 4:

The energy storage device recited in any one of Items 1 to 3, wherein
the welded part comprises a linear portion in a plane view.

### Item 5:

The energy storage device recited in any one of Items 1 to 4, wherein
the welded part comprises a first weld line and a second weld line in a plane view, and
the first weld line and the second weld line are configured to extend in different directions from each other, and configured to cross each other on at least one point.

### Item 6:

The energy storage device recited in any one of Items 1 to 5, wherein
the metallic piece is provided at an outer side of the case.

### Item 7:

The energy storage device recited in any one of Items 1 to 6, wherein
the case comprises a cylindrical body comprising openings at both ends and comprises a pair of sealing plates configured to seal the openings, and
the welded part is provided on the body.

### Item 8:

The energy storage device recited in any one of Items 1 to 7, wherein
the first metal is aluminum or aluminum alloy, and the second metal is copper or copper alloy.

### Item 9:

The energy storage device recited in any one of Items 1 to 8, wherein
the first metal is an H steel that is made of aluminum or aluminum alloy.

What is claimed is:

1. An energy storage device, comprising:
a case that is made of a first metal;
a metallic piece that is welded to the case and that is made of a second metal being different from the first metal; and
an intermetallic compound of the first metal and the second metal, the intermetallic compound being provided on a welded part of the case and the metallic piece.

2. The energy storage device according to claim 1, wherein
the case comprises the welded part as a gas exhaust part.

3. The energy storage device according to claim 2, wherein
the welded part is configured to be broken when an internal pressure of the case reaches 1.0 MPa.

4. The energy storage device according to claim 1, wherein
the welded part comprises a linear portion in a plane view.

5. The energy storage device according to claim 4, wherein
the welded part comprises a first weld line and a second weld line in a plane view, and
the first weld line and the second weld line are configured to extend in different directions from each other, and configured to cross each other on at least one point.

6. The energy storage device according to claim 1, wherein
the metallic piece is provided at an outer side of the case.

7. The energy storage device according to claim 1, wherein
the case comprises a cylindrical body comprising openings at both ends and comprises a pair of sealing plates configured to seal the openings, and
the welded part is provided on the body.

8. The energy storage device according to claim 1, wherein
the first metal is aluminum or aluminum alloy, and the second metal is copper or copper alloy.

9. The energy storage device according to claim 8, wherein
the first metal is an H steel that is made of aluminum or aluminum alloy.
